(19) United States
(12) Patent Application Publication
(10) Pub. No.: US 2011/0157510 A1
(43) Pub. Date: Jun. 30, 2011

(54) PANEL FABRICATING METHOD, PANEL AND DISPLAY PANEL STRUCTURE

(75) Inventors: Chih-Chung HSU, Tainan County (TW); Chien-Chung LIU, Tainan County (TW); Cheng-Ming HUANG, Tainan County (TW)

(73) Assignee: CHIMEI INNOLUX CORP., Tainan County (TW)

(21) Appl. No.: 12/859,586

(22) Filed: Aug. 19, 2010

(30) Foreign Application Priority Data
Aug. 19, 2009 (TW) 98127878

(51) Int. Cl. G02F 1/1333; H01J 9/00; H01J 5/00

(52) U.S. Cl. 349/56; 445/24; 313/317

(57) ABSTRACT

A panel fabricating method is provided. A first substrate having at least two first units arranged along a first direction is provided, wherein each first unit has a first display region and a terminal region sequentially arranged along the first direction. A second substrate having at least two second units arranged along the first direction is provided, wherein each second unit has a second display region and a removal region sequentially arranged along the first direction. The first substrate and the second substrate are stacked so that each first display region is opposite to each second display region and each terminal region is opposite to each removal region, so as to form a plurality of panels. The second substrate is cut in a discontinuous manner along the first direction to form at least one first discontinuous cut portion, wherein the first discontinuous cut portion is partially overlapped with the removal region.

### BACKGROUND

1. Technical Field

The present disclosure generally relates to a panel fabricating method and a panel and a display panel structure fabricated by the panel fabricating method. In particular, to a panel fabricating method that can effectively remove a removal region of a color filter substrate and a panel and a display panel structure fabricated by the panel fabricating method.

2. Description of Related Art

FIG. 1A is a perspective view of a conventional mother panel. FIG. 1B is a perspective view of a panel cut from a mother panel. Referring to FIG. 1A first, the mother panel 100 includes a color filter substrate 110 and a thin film transistor (TFT) array substrate 120 that are attached together. The mother panel 100 is divided into a plurality of panels 130. Each panel 130 has a display region 132 and a terminal region 134. Then referring to FIG. 1B, the color filter substrate 110 at the terminal region 134 of each panel 130 is removed to expose the circuit (not shown) on the TFT array substrate 120 corresponding to the terminal region 134.

FIG. 2 is a diagram illustrating a conventional for cutting a mother panel by using a cutting wheel. The mother panel 100 may be cut by using the cutting wheel 210 illustrated in FIG. 2. Referring to FIG. 2, the substrates 102 adopted in the color filter substrate 110 and the TFT array substrate 120 are usually made of glass. When a stress G1 is applied to predetermined cutting locations on a substrate 102 by using the cutting wheel 210 to cut the substrate 102 along the cutting route D, a vertical crack 220 and horizontal cracks 230 at both sides of the vertical crack 220 are formed in the substrate 102. Then, a forward stress G2 is applied to the substrate 102 to break the substrate 102 along the cutting route D and generate rib marks M on the cutting surface, as shown in FIG. 3.

FIG. 4 is a top view illustrating predetermined cutting locations on a mother panel. Referring to FIG. 4, the TFT array substrate 120 is illustrated in front of the color filter substrate 110. In order to better explain the cutting process, it is illustrated in FIG. 4 from the side of the TFT array substrate 120.

Referring to FIG. 4, first, the mother panel 100 is transmitted in the transmission direction F. Namely, the mother panel 100 is transmitted with the color filter substrate 110 being placed on the conveyor belt (not shown).

Then, the substrates 110 and 120 are cut by using the cutting wheel 210 illustrated in FIG. 2 in the direction of the X axis along a plurality of horizontal cutting directions 310. It should be noted that the horizontal cutting directions 310 are categorized into non-aligned sides 310A and aligned sides 310B. To be specific, referring to the panel 130 at the bottom left corner of FIG. 4, in the direction of the X axis, the non-aligned side 310A refers to the side that the edge of the color filter substrate 110 and the edge of the TFT array substrate 120 do not overlap each other (the lower side), and the aligned side 310B refers to the side that the edge of the color filter substrate 110 and the edge of the TFT array substrate 120 overlap each other (the upper side).

The method for cutting the mother panel 100 in the direction of the X axis is as follows. The cutting wheel 210 has different dispositions and ways of cutting at the non-aligned sides 310A and the aligned sides 310B. At the non-aligned sides 310A, two cutting wheels 210 which are disposed in a staggered way are used at the same time for cutting the substrates 110 and 120. Herein a set of cutting wheels 210 which are vertically staggered is used for respectively cutting the substrates 120 and 110 at the same time along the cutting lines 310A1 and 310A2. In addition, at the aligned sides 310B, a set of cutting wheels 210 which are also vertically staggered is used for cutting the substrates 110 and 120 at the same time along the aligned sides 310B. As shown in FIG. 4, six cuttings are performed in the direction of the X axis (i.e., three non-aligned sides 310A and three aligned sides 310B).

The method for cutting the mother panel in the direction of the Y axis is as follows. The vertical cutting directions 320 are also categorized into non-aligned sides 320A and aligned-sides 320B. In the direction of the Y axis, the substrates 110 and 120 are cut at the same time along the vertical cutting directions 320. To be specific, at the non-aligned sides 320A, two sets of cutting wheels 210 which are disposed in a staggered way are used at the same time for cutting the mother panel 100. Herein a set of cutting wheels 210 which are vertically staggered is used for cutting the substrates 120 and 110 at the same time along the cutting lines 320A1 and 320A2. In addition, at the aligned-sides 320B, a set of cutting wheels 210 which are vertically staggered is used for cutting the substrates 110 and 120 at the same time along the aligned-sides 320B. As shown in FIG. 4, eight cuttings are performed in the direction of the Y axis (i.e., four non-aligned sides 320A and four aligned-sides 320B).

After the cutting process is complete, as shown in FIG. 5, the panels 130 are held by using a suction device (not shown). Namely, the panels 130 are lifted up (i.e., inwards in FIG. 5) by a tensile stress T, and a compressive stress P that is applied to the residual material RE, so that the panels 130 and the residual material RE can be separated. However, the mother panel cutting method described above leaves the residual material RE between the panels 130 therefore results in waste of material.

FIG. 6 is a top view of another conventional mother panel and predetermined cutting locations thereon. Referring to FIG. 6, in the mother panel 100a, a plurality of panels 130 is disposed next to each other along the Y axis so that less residual material RE is formed on the mother panel 100a. Similar to the mother panel 100 illustrated in FIG. 4, in the mother panel 100a, in the direction of the X axis, the horizontal cutting directions 310 are also categorized into non-aligned sides 310A and aligned sides 310B, wherein the non-aligned sides 310A have two cutting lines 310A1 and 310A2. In the direction of the Y axis, the vertical cutting directions 320 are categorized into non-aligned sides 320A and aligned-sides 320B, wherein the non-aligned sides 320A have two cutting lines 320A1 and 320A2. The cutting processes in the direction of the X axis and in the direction of the Y axis are similar to that illustrated in FIG. 4 therefore will not be described herein.

FIG. 7 is a side view along line A-A′ in FIG. 6. Referring to FIG. 7, regarding the cutting process in the direction of the X axis, the cutting wheel 210 and a roller L are moved along the direction of the X axis to cut the mother panel 100a. It should be noted that referring to FIG. 7, the cutting wheel 210 is only used for continuously cutting the lower color filter substrate 110 along the cutting line 310A1, while the roller L is run over the opposite TFT array substrate 120.

Even though less residual material RE is left by arranging the panels 130 by the method described above, the removal regions R on the color filter substrate 110 are set in the mother panel 100a therefore are difficult to remove. Because the removal regions R cannot be detected precisely, it is difficult to remove them by using a suction device. As a result, a problem of an abnormal edge appearance is caused during a subsequent edge grinding process. In addition, when the color filter substrate 110 is moved before the removal regions R are removed, the removal regions R may drop onto the mother panel 100a and accordingly fragments of the removal regions R may be produced.

### SUMMARY

Accordingly, the present disclosure is directed to a panel fabricating method, wherein residual materials and removal regions on a color filter substrate can be removed at the same time.

The present disclosure is also directed to a panel fabricated by the aforementioned panel fabricating method, wherein the use efficiency of a material and the fabrication yield of the panel are both improved.

The present disclosure is further directed to a display panel structure with improved fabrication yield and display quality.

The present disclosure provides a panel fabricating method. First, a first substrate is provided, wherein the first substrate has at least two first units arranged along a first direction, and each of the first units has a first display region and a terminal region sequentially arranged along the first direction. Then, a second substrate is provided, wherein the second substrate has at least two second units arranged along the first direction, and each of the second units has a second display region and a removal region sequentially arranged along the first direction. Next, the first substrate and the second substrate are stacked so that each first display region is opposite to each second display region and each terminal region is opposite to each removal region, so as to form at least two panels. After that, the second substrate is cut in a discontinuous manner along the first direction to form at least one first discontinuous cut portion, wherein the first discontinuous cut portion is partially overlapped with the removal region.

According to an embodiment of the present disclosure, each of the panels has a display region disposed opposite to the first display region and the second display region, the adjoining terminal region, and the removal region opposite to the terminal region sequentially arranged along the first direction.

According to an embodiment of the present disclosure, the first discontinuous cut portion has an extension length between 100 μm and 1,000 μm in the first direction.

According to an embodiment of the present disclosure, the first direction is a horizontal direction.

According to an embodiment of the present disclosure, the first direction is a vertical direction.

According to an embodiment of the present disclosure, the panel fabricating method further includes cutting the panel in a discontinuous manner along a second direction unparallel to the first direction to form at least one second discontinuous cut portion, wherein the second discontinuous cut portion has an extension length between 100 μm and 1,000 μm in the second direction.

According to an embodiment of the present disclosure, the first substrate is an active device array substrate.

According to an embodiment of the present disclosure, the second substrate is a color filter substrate.

The present disclosure also provides a panel fabricated by the panel fabricating method described above, wherein a cutting surface of the first discontinuous cut portion has no rib mark.

The present disclosure further provides a panel fabricated by the panel fabricating method described above, wherein a cutting surface of the first discontinuous cut portion and a cutting surface of the second discontinuous cut portion have no rib mark.

The present disclosure still provides a display panel structure including a first substrate and a second substrate. The first substrate has a display region, a terminal region, and a first side. The second substrate is stacked with the first substrate and has a second side aligned with the first side. Only a part of the first side has rib marks.

According to an embodiment of the present disclosure, the first substrate is an active device array substrate. The active device array substrate includes a scan line, a data line, a plurality of active devices, and a plurality of pixel electrodes. The active devices are electrically connected to the scan line and the data line. The pixel electrodes are electrically connected to the drains of the active devices.

According to an embodiment of the present disclosure, the second substrate is a color filter substrate. The color filter substrate includes a transparent substrate, a color filter layer, and a common electrode. The color filter layer is disposed on the transparent substrate. The common electrode is disposed on the color filter layer.

According to an embodiment of the present disclosure, the display panel structure further includes a liquid crystal layer disposed between the first substrate and the second substrate.

In the panel fabricating method provided by the present disclosure, discontinuous cut portions are formed on the second substrate by jump cutting, and the discontinuous cut portions are stacked with the removal regions on the second substrate. The removal regions on the second substrate can be easily removed by the discontinuous cut portions. By fabricating a panel and a display panel structure by the panel fabricating method described above, the material cost can be reduced, and the use efficiency of the mother panel and the fabrication yield of the panel can be improved.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a perspective view of a conventional mother panel.

FIG. 1B is a perspective view of a panel cut from a mother panel.

FIG. 2 is a diagram illustrating how conventionally a mother panel is cut by using a cutting wheel.

FIG. 3 is a diagram illustrating how conventionally a cutting surface of a mother panel is cut by using a cutting wheel.

FIG. 4 is a top view illustrating predetermined cutting locations on a mother panel.

FIG. 5 is a diagram illustrating how a panel is lifted by using a suction device.

FIG. 6 is a top view of another conventional mother panel and predetermined cutting locations thereon.

FIG. 7 is a side view along line A-A′ in FIG. 6.

FIG. 8A is a perspective explosion view of a mother panel according to a first embodiment of the present disclosure.

FIG. 8B is a perspective view of a panel in FIG. 8A.

FIG. 9 is a top view illustrating predetermined cutting locations on the mother panel in FIG. 8A.

FIG. 10 is a top view illustrating predetermined cutting locations on a mother panel according to a second embodiment of the present disclosure.

FIG. 11 is a top view illustrating predetermined cutting locations on a mother panel according to a third embodiment of the present disclosure.

FIG. 12 is a diagram illustrating a cutting surface of a panel fabricated by a conventional cutting technique.

FIG. 13 is a diagram illustrating a cutting surface of a panel fabricated by a mother panel cutting technique provided by the present disclosure.

FIG. 14 is a perspective view of a display panel structure according to an exemplary embodiment of the present disclosure.

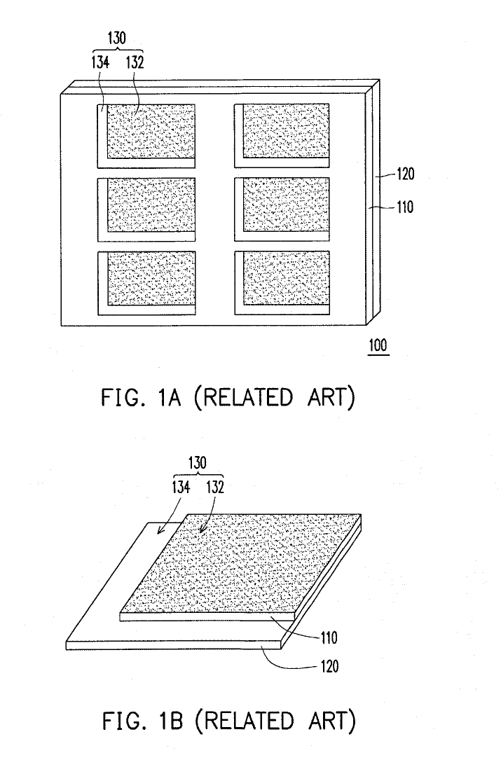

### DETAILED DESCRIPTION

Reference will now be made in detail to the present preferred embodiments of the disclosure, examples of which are illustrated in the accompanying drawings. Wherever possible, the same reference numbers are used in the drawings and the description to refer to the same or like parts.

### Panel Fabricating Method

### First Embodiment

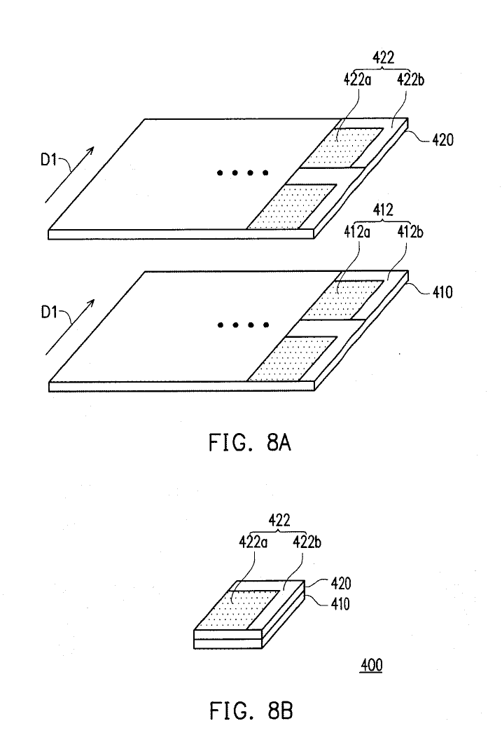

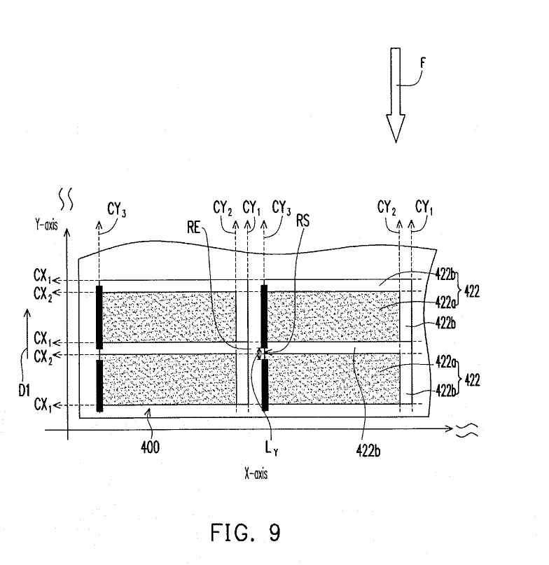

FIG. 8A is a perspective explosion view of a mother panel according to the first embodiment of the present disclosure. FIG. 8B is a perspective view of a panel in FIG. 8A. FIG. 9 is a top view illustrating predetermined cutting locations on the mother panel in FIG. 8A.

Referring to FIG. 8A, first, a first substrate 410 is provided. The first substrate 410 has at least two first units 412 arranged along a first direction Dl, wherein each of the first units 412 has a first display region 412a and a terminal region 412b sequentially arranged along the first direction D1 . The first substrate 410 may be an active device array substrate.

Then, a second substrate 420 is provided. The second substrate 420 has at least two second units 422 that are also arranged along the first direction D1, wherein each of the second units 422 has a second display region 422a and a removal region 422b sequentially arranged along the first direction D1. The second substrate 420 may be a color filter substrate.

Next, referring to both FIG. 8A and FIG. 8B, the first substrate 410 and the second substrate 420 are stacked so that each first display region 412a is opposite to each second display region 422a and each terminal region 412b is opposite to each removal region 422b, so as to form at least two panels 400. Only the second unit 422 of the second substrate 420 at the top are illustrated in FIG. 8B.

After that, referring to FIG. 9, the second substrate 420 is cut in a discontinuous way along the first direction D1 to form at least one discontinuous cut portion RS, wherein the discontinuous cut portion RS is partially overlapped with the removal region 422b.

The cutting process is explained below in detail as follows. It should be noted that in FIG. 9, the second substrate 420 is illustrated in front of the first substrate 410. As shown in FIG. 9, in the present embodiment, the first direction D1 is assumed to the vertical direction (Y), and a discontinuous cutting process is performed in the vertical direction.

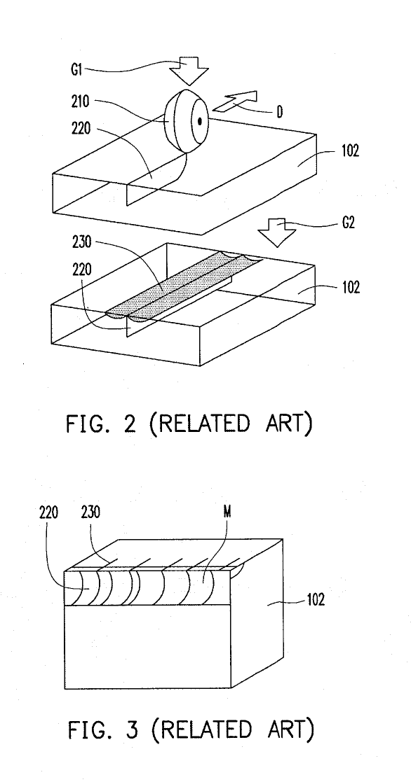

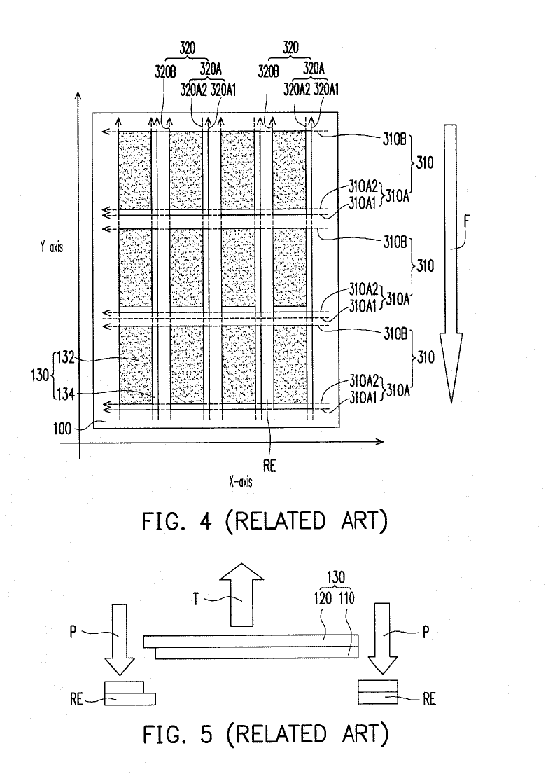

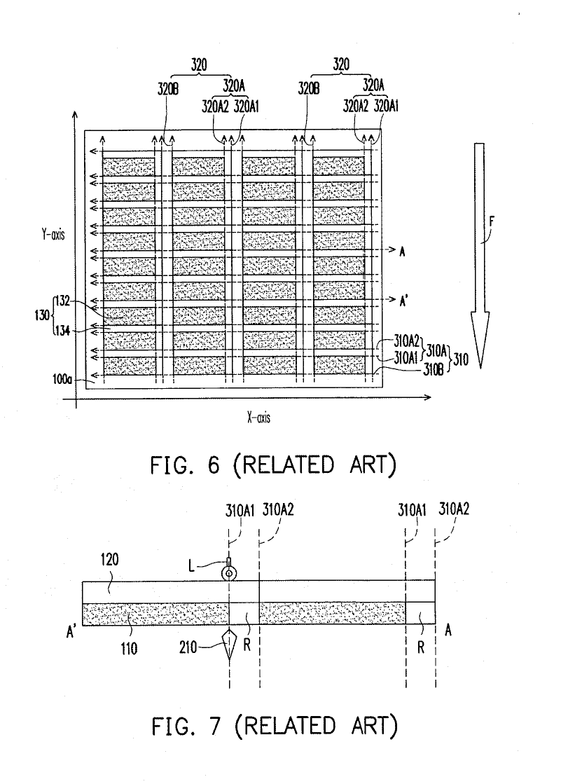

Referring to FIG. 9 again, CX₁ and CX₂ are cutting lines in the direction of the X axis, and CY₁, CY₂, and CY₃ are cutting lines in the direction of the Y axis. To be specific, the second substrate 420 is cut along the cutting line CX₂ by using the cutting wheel 210 illustrated in FIG. 2 using a single-sided feed, and meanwhile, the cutting wheel 210 is supported from the other side by using a roller (not shown), as shown in FIG. 7. In addition, the substrates 410 and 420 are simultaneously cut in a staggered manner along the cutting lines CY₁ and CY₂ using a double-sided feed. The substrates 410 and 420 are respectively cut along the cutting lines CX₁ and CY₃ using a double-sided feed. Herein the second substrate 420 is cut along the cutting line CY₃ as indicated by the bold lines in FIG. 9.

In particular, the second substrate 420 is discontinuously cut along the cutting line CY₃ by jump cutting, so as to form the discontinuous cut portion RS. Meanwhile, the first substrate 410 is continuously cut. The discontinuous cut portion RS is overlapped and connected with the removal region 422b of the second substrate 420 (the portion not indicated by bold lines).

Accordingly, the removal region 422b is connected with the residual material RE by the discontinuous cut portion RS. The removal region 422b connected with the discontinuous cut portion RS can be easily removed at the same time when the residual material RE is removed. In other words, because the removal region 422b of the second substrate 420 is not set between two adjoining panels 400 by itself, the problem of abnormal edge appearance in subsequent edge grinding process caused by un-removed removal region 422b is resolved.

Referring to FIG. 9 again, the extension length Ly of the discontinuous cut portion RS in the first direction D1 is between 100 μm and 1,000 μm. It should be stated herein that when the extension length L_{Y} is within this range, the panel 400 can be effectively separated without being damaged at the discontinuous cut portion RS in subsequent step for lifting the panel 400.

As described above, the panel fabricating method increases the material use efficiency and can be adopted for cutting more panels 410. In particular, because the removal region 422b is connected to the residual material RE by the discontinuous cut portion RS, the removal region 422b on the second substrate 420 can be easily removed by the residual material RE. Thus, related problems (for example, chippings and torn edges) caused by the difficult removal of the removal region 422b on the second substrate 420 can be resolved.

### Second Embodiment

FIG. 10 is a top view illustrating predetermined cutting locations on a mother panel according to the second embodiment of the present disclosure. The cutting method in the present embodiment is similar to that in the first embodiment, and the similar part will not be described herein. The difference between the two embodiments is that as shown in FIG. 10, the first direction D1 in the present embodiment is set to be the horizontal direction (X), and the mother panel is cut in a discontinuous manner in the horizontal direction.

To be specific, besides performing a continuous cutting along the cutting lines CY₁-CY₃ and CX₂ using a double-sided feed, in the present embodiment, the second substrate 420 is cut by jump cutting along the cutting line CX₁ to form the discontinuous cut portion RS. The portions that are cut along the cutting line CX₁ are indicated by the bold lines in FIG. 10.

Referring to FIG. 10 again, the second substrate 420 is cut in a discontinuous manner along the first direction D1 (the horizontal direction) to form at least one discontinuous cut portion RS, wherein the discontinuous cut portion RS is partially overlapped with the removal region 422b. Herein the next second display region 422a on the second substrate 420 is connected with the removal region 422b by the discontinuous cut portion RS. When the panel 400 is lifted by using a suction device, the previous removal region 422b on the second substrate 420 is also exposed so that the removal region 422b on the second substrate 420 can be easily removed.

Similarly, the extension length L_{X} of the discontinuous cut portion RS is between 100 μm and 1,000 μm. Similar to that described in the first embodiment, the panel 400 can be effectively separated without being damaged at the discontinuous cut portion RS by the setting of the extension length L_{X}.

### Third Embodiment

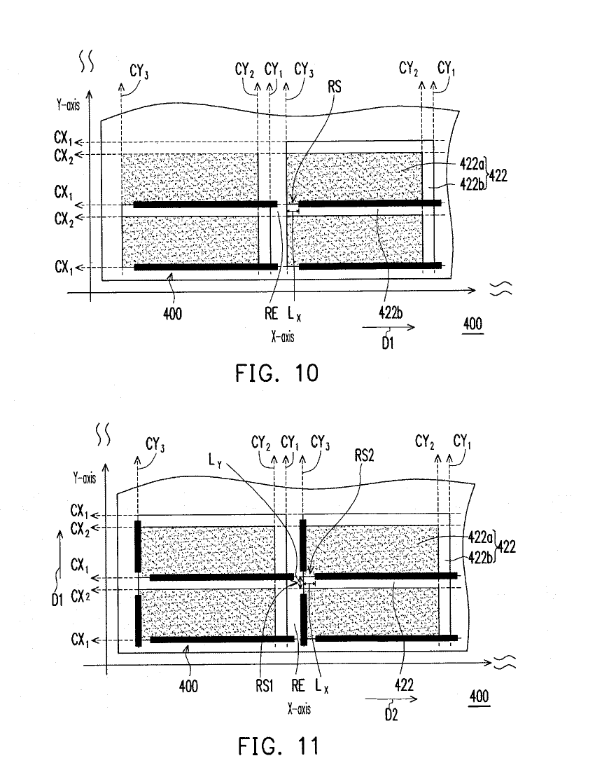

FIG. 11 is a top view illustrating predetermined cutting locations on a mother panel according to the third embodiment of the present disclosure. The cutting method in the present embodiment is similar to those in the first and the second embodiment therefore will not be described herein. It should be noted that in the present embodiment, referring to FIG. 11, besides cutting the panel 400 in a discontinuous manner along the first direction D1 (i.e., the vertical direction) to form a discontinuous cut portion RS1, the panel 400 is further cut in a discontinuous manner along a second direction D2 (i.e., the horizontal direction) that is not parallel to the first direction D1 to form another discontinuous cut portion RS2. Namely, the panel 400 is cut in both the vertical and horizontal directions in a discontinuous manner.

The extension length L_{Y} of the discontinuous cut portion RS1 in the first direction D1 is between 100 μm and 1,000 μm, and the extension length L_{X} of the discontinuous cut portion RS2 in the second direction D2 is between 100 μm and 1,000 μm. The panel 400 can be effectively separated without being damaged at the discontinuous cut portions RS1 and RS2.

In summary, the discontinuous cut portions RS, RS1, and RS2 are formed on the second substrate 420 by jump cutting, so that the removal region 422b on the second substrate 420 can be removed by the discontinuous cut portions RS, RS1, and RS2. The arrangement of the panels 400 in the first, second, and third embodiments described above is only an example but not intended to limit the present disclosure. The panels 400 may also be closely disposed along the horizontal direction X (not shown), and two adjacent rows of panels 400 are separated by the residual material RE in the vertical direction Y. The arrangement, cutting direction, and transmitting direction of the panels 400 may be determined by those having knowledge in the art according to the actual requirement of an actual application. It is within the scope of the present disclosure as long as the discontinuous cut portion RS is formed by jump cutting.

### Panel Fabricated Using the Panel Fabricating Method

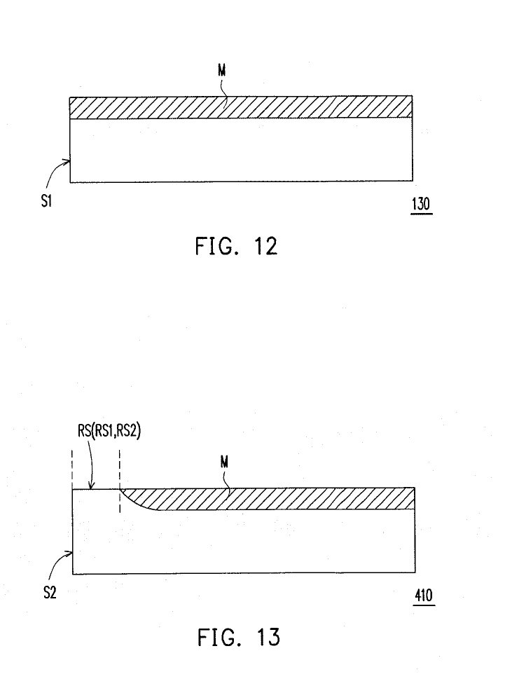

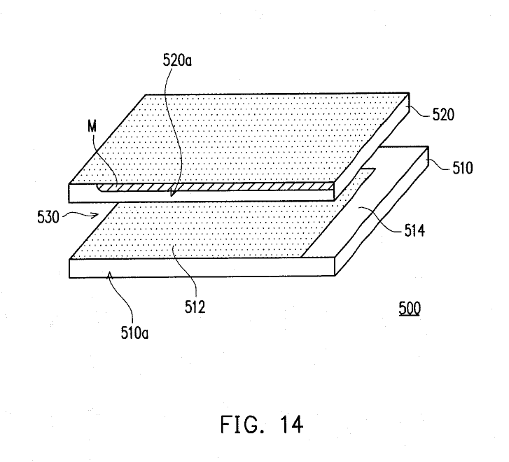

FIG. 12 is a diagram illustrating a cutting surface of a panel fabricated by a conventional cutting technique. FIG. 13 is a diagram illustrating a cutting surface of a panel fabricated by a mother panel cutting technique provided by the present disclosure. It should be mentioned that the cutting surface of the panel 400 in the present disclosure is different from that of the panel 130 fabricated by the conventional cutting technique.

Referring to FIG. 2, FIG. 3, and FIG. 12 regarding the conventional technique and FIG. 9, FIG. 10, FIG. 11, and FIG. 13 regarding the present disclosure, because the mother panel 100 is cut by the conventional technique in a continuous manner, the cutting surface Si of the panel 130 has continuous rib marks M.

However, when the mother panel is cut by the method provided by the present disclosure to obtain the panels 400, a jump cutting operation is performed at the discontinuous cut portions RS, RS1, and RS2. Thus, the cutting surface S2 has no rib mark M at the discontinuous cut portions RS, RS1, and RS2.

To be specific, referring to FIG. 9, in the first embodiment, the cutting surface at the discontinuous cut portion RS on which jump cutting is performed in the vertical direction has no rib mark M. Referring to FIG. 10, in the second embodiment, the cutting surface at the discontinuous cut portion RS on which jump cutting is performed in the horizontal direction has no rib mark M. Referring to FIG. 11, in the third embodiment, the cutting surfaces at the discontinuous cut portions RS1 and Rs2 on which jump cutting is performed in both vertical and horizontal directions have no rib mark.

The area on the panel 400 that has no rib mark M varies with different dispositions of the discontinuous cut portions RS, RS1, and RS2 as illustrated in FIG. 9, FIG. 10, and FIG. 11. The dispositions and cuttings of the discontinuous cut portions RS, RS1, and RS2 have been described in foregoing first, second, and third embodiments therefore will not be described herein. It can be determined that the panel 400 is fabricated by the panel fabricating method provided by the present disclosure if only a part of the panel 400 has the rib marks M. Additionally, the discontinuous cut portions RS, RS1, and RS2 are not limited to be formed on the second substrate 420, and the jump cutting operation can be performed on both the first substrate 410 and the second substrate 420 to form the discontinuous cut portions RS, RS1, and RS2 at the same time.

### Display Panel Structure

FIG. 14 is a perspective view of a display panel structure according to an exemplary embodiment of the present disclosure. Referring to FIG. 14, the display panel structure 500 includes a first substrate 510 and a second substrate 520. The first substrate 510 has a display region 512, a terminal region 514, and a first side 510a. The second substrate 520 is stacked with the first substrate 510 and has a second side 520a aligned with the first side 510a. Herein only a part of the second side 520a has rib marks M.

The first substrate 510 may be an active device array substrate, and the active device array substrate includes a scan line and a data line (not shown), a plurality of active devices (not shown), and a plurality of pixel electrodes (not shown). The active devices are electrically connected to the scan line and the data line. The pixel electrodes are electrically connected to the drains of the active devices. The active devices may be thin film transistors (TFTs). The active device array substrate is well known by those having ordinary knowledge in the art and, therefore, is not described herein.

The second substrate 520 may be a color filter substrate, and the color filter substrate includes a transparent substrate (not shown), a color filter layer (not shown), and a common electrode (not shown). The color filter layer is disposed on the transparent substrate. The common electrode is disposed on the color filter layer. Because the color filter substrate is well known by those having ordinary knowledge in the art the color filter substrate is not described herein. In addition, the display panel structure 500 may further include a liquid crystal layer 530 disposed between the first substrate 510 and the second substrate 520.

The display panel structure 500 may adopt a panel 400 fabricated by a method provided by foregoing first, second, or third embodiments. It should be noted that only a part of the second side 520a of the display panel structure 500 has rib marks M, and the part having no rib mark M corresponds to the discontinuous cut portions RS, RS1, and RS2 in the first, second, or third embodiments. It can be determined that the panel adopted by the display panel structure 500 is fabricated by the panel fabricating method in the present disclosure when only a part of the display panel structure 500 has the rib marks M.

In summary, the panel fabricating method, panel, and display panel structure provided by the present disclosure have at least the following advantages.

Discontinuous cut portions are formed on the second substrate by jump cutting, and the removal region on the second substrate between two adjacent panels is removed by the discontinuous cut portions. Thus, problems in subsequent process caused by un-removed removal regions on the second substrate can be resolved. By fabricating panels and display panel structures by the panel fabricating method described above, the material cost is reduced, the use efficiency of the mother panel is improved, and the fabrication yield of the panels is increased.

It will be apparent to those skilled in the art that various modifications and variations can be made to the structures or methods of the present disclosure without departing from the scope or spirit of the invention. In view of the foregoing, it is intended that the present disclosure cover modifications and variations of this disclosure provided they fall within the scope of the following claims and their equivalents.

What is claimed is:

1. A panel fabricating method, comprising:
providing a first substrate, wherein the first substrate has at least two first units arranged along a first direction, and each of the first units has a first display region and a terminal region sequentially arranged along the first direction;
providing a second substrate, wherein the second substrate has at least two second units arranged along the first direction, and each of the second units has a second display region and a removal region sequentially arranged along the first direction;
stacking the first substrate and the second substrate so that each of the first display regions is opposite to each of the second display regions and each of the terminal regions is opposite to each of the removal regions, so as to form at least two panels;
cutting the second substrate in a discontinuous manner along the first direction to form at least one first discontinuous cut portion, wherein the first discontinuous cut portion is partially overlapped with the removal region.

2. The panel fabricating method according to claim 1, wherein each of the panels has a display region disposed opposite to the first display region and the second display region, the adjoining terminal region, and the removal region opposite to the terminal region sequentially arranged along the first direction.

3. The panel fabricating method according to claim 1, wherein the first discontinuous cut portion has an extension length between 100 μm and 1,000 μm in the first direction.

4. The panel fabricating method according to claim 1, wherein the first direction is a horizontal direction X.

5. The panel fabricating method according to claim 1, wherein the first direction is a vertical direction Y.

6. The panel fabricating method according to claim 1 further comprising:
cutting the panel in a discontinuous manner along a second direction unparallel to the first direction to form at least one second discontinuous cut portion.

7. The panel fabricating method according to claim 6, wherein the second discontinuous cut portion has an extension length between 100 μm and 1,000 μm in the second direction.

8. The panel fabricating method according to claim 1, wherein the first substrate is an active device array substrate.

9. The panel fabricating method according to claim 1, wherein the second substrate is a color filter substrate.

10. A panel, fabricated by the panel fabricating method according to claim 1, wherein
a cutting surface of the first discontinuous cut portion has no rib mark.

11. A panel, fabricated by the panel fabricating method according to claim 6, wherein
a cutting surface of the first discontinuous cut portion and a cutting surface of the second discontinuous cut portion have no rib mark.

12. A display panel structure, comprising:
a first substrate, having a display region, a terminal region and a first side;
a second substrate, stacked with the first substrate, and having a second side aligned with the first side;
wherein only a part of the second side has rib marks.

13. The display panel structure according to claim 12, wherein the first substrate is an active device array substrate.

14. The display panel structure according to claim 13, wherein the active device array substrate comprises:
a scan line and a data line;
a plurality of active devices, electrically connected to the scan line and the data line; and
a plurality of pixel electrodes, electrically connected to drains of the active devices.

15. The display panel structure according to claim 12, wherein the second substrate is a color filter substrate.

16. The display panel structure according to claim 15, wherein the color filter substrate comprises:
a transparent substrate;
a color filter layer, disposed on the transparent substrate; and
a common electrode, disposed on the color filter layer.

17. The display panel structure according to claim 12 further comprising a liquid crystal layer disposed between the first substrate and the second substrate.
